(19) United States
(12) Patent Application Publication
(10) Pub. No.: US 2014/0156397 A1
(43) Pub. Date: Jun. 5, 2014

(54) LIFESTYLE GRILL

(71) Applicant: TETON ACQUISITIONS, LLC, Plymouth, MN (US)

(72) Inventor: Howard R. Tripp, II, Plymouth, MN (US)

(73) Assignee: TETON ACQUISITIONS, LLC, Plymouth, MN (US)

(21) Appl. No.: 13/894,981

(22) Filed: May 15, 2013

Related U.S. Application Data
(63) Continuation of application No. 12/953,176, filed on Nov. 23, 2010, now abandoned.
Application No. 12/953,176 is a division of application No. 11/294,686, filed on Dec. 5, 2005, now abandoned.

(51) Int. Cl. G06Q 30/02

(52) U.S. Cl. CPC G06Q 30/0255
USPC 705/14.53

(57) ABSTRACT

Methods for manufacturing grills, methods for marketing grills, and grills. An example method for manufacturing a grill includes providing a grill base and lid, fabricating a plurality of accessory parts for the grill that are tailored to a lifestyle, and attaching the accessory parts to the grill base. An example method for target marketing grills includes providing a grill, selecting a theme for the grill that is tailored to a lifestyle, fabricating parts for the grill that are tailored to the lifestyle, attaching the parts to the grill base, and promoting the grill to persons who have the lifestyle. An example grill includes a grill base, a lid, and a number of accessory parts attached to the grill base.

### RELATED APPLICATIONS

This application is a continuation of U.S. application Ser. No. 12/953,176 filed Nov. 23, 2010, which is a divisional of U.S. application Ser. No. 11/294,686 filed Dec. 5, 2005.

### FIELD OF THE INVENTION

The present invention pertains to grills. More particularly, the present invention pertains to methods for making grills, methods for making accessory parts for grills, methods for target marketing grills to a lifestyle, accessory parts for grills, and to grills.

### BACKGROUND

Mankind's fascination with fire traces back to the very origins of life. Since capturing fire, mankind has steadily moved toward better, tastier, and more efficient ways of using fire to prepare food. Along the way, the concept of cooking with fire developed in to modern day barbecue grilling. In fact, when George A. Stephen (the founder of The Weber-Stephen Product Co.) turned a metal buoy into a kettle grill in 1951, mankind's interest in cooking food over fire was increased—if not outright kindled to a proverbial inferno.

Modern day “grillers” utilize a vast array of tools when practicing their craft. These tools include a wide variety of gas, charcoal, and wood grills and barbecues as well as the appropriate accessories that aid in the use of the grills. In fact, a summertime trip to any local hardware or home improvement center is sure to display a variety of these tools from which the discerning griller can select their personal favorites. In deciding between which grills and accessories to use, the customer may weigh some of the features of a given tool such as the fuel source utilized (e.g., gas, charcoal, etc.), price, features of the grill, brand, etc.

### BRIEF SUMMARY

The present invention provides manufacturing method, target marketing method, design, material alternatives for grills, and material alternatives for accessory parts for grills. An example method for manufacturing a grill includes providing a grill base, fabricating a plurality of accessory parts for the grill that are tailored to a lifestyle, and attaching the accessory parts to the grill base. An example method for target marketing grills includes providing a grill, selecting a theme for the grill that is tailored to a lifestyle, fabricating parts for the grill that are tailored to the lifestyle, attaching the parts to the grill base, and promoting the grill to persons who have the lifestyle. An example grill includes a grill base and a number of accessory parts attached to the grill base. Some additional details regarding these and other embodiments are described in more detail below.

### BRIEF DESCRIPTION OF THE DRAWINGS

The invention may be more completely understood in consideration of the following detailed description and examples of various embodiments of the invention in connection with the accompanying drawings, in which:

FIG. 1 is a perspective view of an example grill;

FIG. 1A is an alternative perspective view of the example grill shown in FIG. 1;

FIG. 2 is a perspective view of an example grill grate for use with the grill depicted in FIG. 1;

FIG. 3 is a perspective view of another example grill;

FIG. 4 is a perspective view of an example grill grate for use with the grill depicted in FIG. 3;

FIG. 5 is a perspective view of another example grill;

FIG. 6 is a perspective view of an example grill grate for use with the grill depicted in FIG. 5;

FIG. 7 is a perspective view of an alternative example grill grate for use with the grill depicted in FIG. 5;

FIG. 8 is a perspective view of an alternative example grill grate for use with the grill depicted in FIG. 5;

FIG. 9 is a perspective view of another example grill;

FIG. 10 is a perspective view of an example grill grate for use with the grill depicted in FIG. 9;

FIG. 11 is a perspective view of another example grill;

FIG. 12 is a perspective view of an example grill grate for use with the grill depicted in FIG. 11;

FIG. 13 is a perspective view of another example grill;

FIG. 14 is a perspective view of an example grill grate for use with the grill depicted in FIG. 13;

FIG. 15 is a perspective view of another example grill;

FIG. 16 is a perspective view of an example grill grate for use with the grill depicted in FIG. 15;

FIG. 17 is a perspective view of another example grill;

FIG. 18 is a perspective view of an example grill grate for use with the grill depicted in FIG. 17;

FIG. 19 is a perspective view of another example grill; and

FIG. 20 is a perspective view of an example grill grate for use with the grill depicted in FIG. 19.

### DETAILED DESCRIPTION

The following description should be read with reference to the drawings wherein like reference numerals indicate like elements throughout the several views. The detailed description, examples, and drawings describe and illustrate example embodiments of the claimed invention.

The present disclosure pertains to methods and articles that are tailored to a lifestyle. In order to more fully explain what the intended meaning of being “tailored to a lifestyle” is, a number of definitions are provided. For the purposes of this disclosure, a “lifestyle” is understood to be the manner in which a person leads their life and/or an underlying and significant interest in an activity that impacts the manner in which the person leads their life. Having a particular lifestyle may be recognized by the person focusing a significant amount of their time participating in the activity, watching or listening to the activity, talking about the activity, learning about the activity, practicing the activity, reading about the activity, improving their skills in the activity, sharing their enthusiasm toward the activity with others, coaching or teaching the activity, collecting the tools used in or associated with the activity, purchasing or shopping for tools used in or associated with the activity, etc. For example, a person with a “fishing lifestyle” (i.e., where the activity that the person has an underlying and significant interest in fishing) may enjoy fishing, watching fishing on television, talking to others about fishing, teaching others to fish, collecting or shopping for fishing-related items (e.g., fishing lures, fishing poles, boats, etc.), and the like. Similarly, a person with a “hunting lifestyle” may enjoy hunting, watching hunting on television, reading hunting magazines, collecting firearms and/or ammunition, etc.

For the purposes of this disclosure, being “tailored to a lifestyle” is understood to mean that the methods and/or grills in question have some aspect to them that is connected to the lifestyle and/or feeds the interest of a person in the lifestyle. In other words, methods and/or grills that are tailored to a lifestyle include method steps or structural features that directly pertain to the given lifestyle. For example, an automobile that is tailored to a fishing lifestyle could have a fishing-related bumper sticker affixed to its bumper whereas an automobile that is tailored to a football lifestyle might include a team-logo flag attached to one of its windows.

Though grilling is widely applicable to all persons, grilling enthusiasts tend to share a number of common life interests or have any one of a number of common lifestyles. In fact, some of these people lead a lifestyle that feeds their interest in these lifestyles, for example, such as sports or the outdoors. The converse is also often true. For example, many persons who have a lifestyle in which they are interested in sports and/or the outdoors often have at least a passive interest in grilling.

Some of the lifestyles contemplated, which may be commonly shared with persons having at least a passive interest in grilling, include:

a sports lifestyle;

a football lifestyle including a professional football (including the NATIONAL FOOTBALL LEAGUE.®. or NFL.®.) lifestyle, a college football (including NCAA.®. football) lifestyle, a high school football lifestyle, combinations thereof, etc.;

a basketball lifestyle including a professional basketball (including the NATIONAL BASKETBALL ASSOCIATION.®. or NBA.®.) lifestyle, a college basketball (including NCAA.®. basketball) lifestyle, a high school basketball lifestyle, an Olympic basketball lifestyle, a men's/boys' basketball lifestyle, a women's/girls' basketball lifestyle, combinations thereof, etc.;

a baseball lifestyle including a professional baseball (including MAJOR LEAGUE BASEBALL.®. or MLB.®.) lifestyle, a minor league baseball lifestyle, a northern league baseball lifestyle, a college baseball lifestyle (including NCAA.®. baseball), a high school baseball lifestyle, an Olympic baseball lifestyle, a softball lifestyle, an Olympic softball lifestyle, combinations thereof, etc.;

a hockey lifestyle including a professional hockey (including NATIONAL HOCKEY LEAGUE.®. or NHL.®.) lifestyle, a junior or semi-professional hockey lifestyle, a college hockey lifestyle (including NCAA.®. hockey), a high school hockey lifestyle, a men's/boys' hockey lifestyle, a women's/girls' hockey lifestyle, an Olympic hockey lifestyle, combinations thereof, etc.;

an automobile racing lifestyle including a NASCAR.®. lifestyle, an INDYCAR.®. lifestyle, a CHAMPIONSHIP AUTO RACING TEAMS.®. (or CART.®.) lifestyle, a FORMULA 1.®. or F1.®.) lifestyle, a NHRA.®. lifestyle, combinations thereof, etc.;

a golf lifestyle including a professional golf (including PROFESSIONAL GOLF ASSOCIATION.®., PGA.®., LADIES' PROFESSIONAL GOLF ASSOCIATION.®., or LPGA.®.) lifestyle, an amateur golf lifestyle, a men's golf lifestyle, a women's golf lifestyle, combinations thereof, etc.;

a hunting lifestyle including a large game hunting lifestyle, a small game hunting lifestyle, a sporting clays lifestyle, a shooting range lifestyle, a deer hunting lifestyle, an elk hunting lifestyle, a Rocky Mountain Elk Foundation (including RMEF.®.) lifestyle, a NATIONAL RIFLE ASSOCIATION.®. (including NRA.®.) lifestyle, a DUCKS UNLIMITED.®. lifestyle, a National Wild Turkey Federation (including NWTF.®.) lifestyle, a pheasant hunting lifestyle, a PHEASANTS FOREVER lifestyle, a moose hunting lifestyle, a bear hunting lifestyle, a turkey hunting lifestyle, a grouse hunting lifestyle, a goose hunting lifestyle, a duck hunting lifestyle, a water fowl hunting lifestyle, a rifle hunting lifestyle, a rifle lifestyle, a shotgun hunting lifestyle, a shotgun lifestyle, a bow hunting lifestyle, a REMINGTON.®. lifestyle, a WINCHESTER.®. lifestyle, a SMITH & WESSON.®. lifestyle, a MOSSY OAK.®. lifestyle, a REALTREE.®. lifestyle, combinations thereof, etc.;

a fishing lifestyle including a freshwater fishing lifestyle, a saltwater fishing lifestyle, a walleye fishing lifestyle, a “muskie” (i.e., muskellunge) fishing lifestyle, a bass fishing lifestyle, a BASSMASTER.®. lifestyle, a B.A.S.S.®. lifestyle, a salmon fishing lifestyle, a trout fishing lifestyle, combinations thereof, etc.;

an outdoors lifestyle including a camping lifestyle, a cabin lifestyle, a lodge lifestyle, a hiking lifestyle, combinations thereof, etc.;

a western lifestyle including a ranching lifestyle, a ranger lifestyle, a cowboy lifestyle, a Texas lifestyle, a lone star lifestyle, a lone star state lifestyle, an American Indian lifestyle, a rodeo lifestyle, etc.;

an equestrian lifestyle;

a recreational vehicle lifestyle including a four-wheeler lifestyle, an all-terrain vehicle lifestyle, a snowmobile lifestyle, a POLARIS.®. lifestyle, an ARCTIC CAT.®. lifestyle, a YAMAHA.®. lifestyle, a SUZUKI.®. lifestyle, a HONDA.®. lifestyle, a tractor lifestyle, a JOHN DEERE.®. lifestyle, etc.;

a motorcycle lifestyle including a HARLEY-DAVIDSON.®. lifestyle, an ORANGE COUNTY CHOPPERS.®. lifestyle, a chopper lifestyle, etc.;

a patriotic lifestyle including an Army lifestyle, a Navy lifestyle, an Air Force lifestyle, a Marine Corps lifestyle (including USMC), a THUNDERBIRDS.®. lifestyle, a BLUE ANGELS.®. lifestyle, etc.;

a tool lifestyle including a hardware lifestyle, a do-it-yourself lifestyle, a CRAFTSMAN.®. lifestyle, a STANLEY.®. lifestyle, a BLACK & DECKER.®. lifestyle, a DEWALT.®. lifestyle, etc.;

combinations thereof; and the like.

For each of the contemplated lifestyles, a number of articles are also contemplated that are associated with the lifestyle. Typically these articles are suggestive of the lifestyle so that the mere visualization of the articles brings to mind the lifestyle. These articles may be incorporated into a number of differing methods for manufacturing grills, methods for target marketing grills, and grills as described in more detail below. Some of the articles may include:

for a sports lifestyle: sporting arenas, binoculars, tennis shoes, jerseys, uniforms, sweaters, scoreboards, portions thereof, combinations thereof, etc.;

for a football lifestyle: footballs, football fields, football tees, football helmets, football team logos, football players, referees/umpires, goal posts, yardage markers, scoreboards, portions thereof, combinations thereof, etc.;

for a basketball lifestyle: basketballs, basketball team logos, basketball hoops, backboards, basketball courts, basketball players, portions thereof, combinations thereof, etc.;

for a baseball lifestyle: baseballs, bats, batting helmets, bases, gloves, baseball fields/stadiums, baseball players, baseball team logos, portions thereof, combinations thereof, etc.;

for a hockey lifestyle: hockey pucks, hockey sticks, hockey equipment, skates, hockey arenas, hockey team logos, hockey players, a ZAMBONI.®., portions thereof, combinations thereof, etc.;

for an automobile racing lifestyle: automobiles/racing vehicles, tail pipes, chrome tail pipes, race tracks (e.g., Daytona, Indianapolis, Talladega, Brickyard, etc.), racing flames, racing wheels, race drivers, the car number of a race driver, tires, tachometer gauges, speedometers, fuel gauges, manual transmission shifter, stick shifter, manual transmission gears, helmets, lug nuts, checkered flags, portions thereof, combinations thereof, etc.;

for a golf lifestyle: golf clubs, irons, woods, putters, golf tees, divot remover, ball markers, golf balls, golf courses (e.g., Augusta National, Pebble Beach, St. Andrews, etc.), golfers, golf holes, scorecards, golf towels, flags/pins, cups, golf cars, golf bags, portions thereof, combinations thereof, etc.;

for a hunting lifestyle: rifles, shotguns, handguns, pistols, revolvers, rifle shells, shotgun shells, shell casings, ammunition, ammunition cartridges, cartridge head stamps, shell head stamps, licenses, hunting knives, hunting cabins, hunting shacks, hunting shanties, duck calls, turkey calls, striker calls, bird calls, goose calls, lanyards with duck bands, lanyards with goose bands, lanyards with turkey bands, duck feathers, goose feathers, turkey feathers, webbed feet, turkey tracks, antlers, deer antlers, moose antlers, elk antlers, ducks, geese, elk, moose, deer, bears, turkeys, camouflage, portions thereof, combinations thereof, etc.;

for a fishing lifestyle: boats, outboard motors, inboard motors, inboard-outboard motors, trailers, fishing rods, fishing reels, fishing nets, fishing baits (live and artificial), stick baits, RAPALA.®. lures, spinner baits, hooks, treble hooks, sinkers, buoys, bobbers, licenses, fish, minnows, worms, night crawlers, grubs, leeches, fish scales, anchors, walleye, muskellunge, trout, salmon, bass, portions thereof, combinations thereof, etc.;

for an outdoors lifestyle: tents, compasses, camp stove, canoes, canoe paddles, oars, maps, trees and tree branches, sticks, twigs, leaves, the woods, trails, cabins, log cabins, lodges, rope, stars, portions thereof, combinations thereof, etc. for a western lifestyle: rope, braided rope, lassos, horse shoes, spurs, cowboy hats, cowboy boots, covered wagons, wagon wheels, steers, steer skulls, stars, a Texas-style star, a lone star, lariats, leather, bandanas, portions thereof, combinations thereof, etc.;

for an equestrian lifestyle; horses (including various horse breeds), jumps, saddles, bridles, whips, spurs, portions thereof, combinations thereof, etc.;

for a recreational vehicle lifestyle: tail pipes, chrome tail pipes, racing flames, tires, tachometer gauges, speedometers, fuel gauges, helmets, four wheelers, snowmobiles, snowmobile skis, snowmobile suits, portions thereof, combinations thereof, etc.;

for a motorcycle lifestyle: motorcycles, helmets, chaps, handle bars, tail pipes, chains, leather, fringed leather, bandanas, portions thereof, combinations thereof, etc.;

for a patriotic lifestyle: Army logos, Army green, HUMMER.®., military weapons, Navy logos, Air Force logos, Marine Corps logos, flags, stars and stripes, medals, patches, uniforms, camouflage, portions thereof, combinations thereof, etc.; and

for a tool lifestyle: nuts, bolts, hand tools, power tools, drills, saws, table saws, chain saws, tool boxes, tool box components, tool belts, tool belt components, screwdrivers, pliers, hammers, tool logos, levels, portions thereof, combinations thereof, etc.

Because of the common link between an interest in grilling and certain lifestyles (e.g., lifestyles in which the person is interested in sports and/or the outdoors), the present invention includes methods for manufacturing grills and accessory parts, methods for target marketing grills, and grills that are tailored to a lifestyle, for example, a sports or outdoors lifestyle. Tailoring these methods and grills to a lifestyle may include the use of any number of suitable articles that are associated with the lifestyle in either the manufacturing methods, target market methods, or grills. Each of the methods and grills are discussed below in general terms. These general descriptions of the methods and grills are meant to serve as a background of the concept that is contemplated and on the sprit of the invention. The examples, found below, illustrate at least some of the embodiments that result when these concepts are implemented.

With these concepts in mind, it is useful to consider a “generic” grill. Such a grill might include the basic parts of a grill such as a grill base. The grill base may have a bowl and a lid coupled to the bowl. Attached to the grill base may be a number of “stock” accessory parts. Some examples of stock accessory parts include carts, cart legs, cart front panels, wheels, control knobs, grill grates, handles, lid panels, lid etchings, and the like. Although these parts are utilized in the methods and grill described herein, the stock accessory parts are different from the accessory parts described above. Most notably, a stock accessory part is not tailored to a lifestyle and, more particularly, is not tailored to any of the lifestyles described above. In addition, because the stock accessory parts are not tailored to a lifestyle, they do not resemble or take the form of any of the articles associated with a particular lifestyle. Therefore, “stock” accessory parts are structurally distinct from the accessory parts described herein that are tailored to a lifestyle and that take the form or resemble an article associated with the lifestyle.

### Methods for Manufacturing Grills

The methods for manufacturing grills generally include fabricating and/or providing the various parts of a grill and putting them together in order to create the grill. A grill is understood to have a number of basic parts such as a grill base. The grill base may include a bowl and a lid coupled to the bowl. A handle may be coupled to the lid. A cart or leg assembly may be coupled to the bowl that holds the bowl and/or raises the bowl to a height that makes the bowl accessible to a user. The base may also include one or more side tables. In some embodiments, the side tables may be attached to the cart and extend laterally therefrom. The side tables may include one or more control knobs, one or more tool hangers, a side burner, and the like. The grill base may also include a number of additional parts.

The methods for manufacturing grills includes providing these parts and putting them together to produce a grill. In addition to providing and putting together these parts, additional method steps are contemplated. Some of these addition method steps include providing and/or fabricating a number of accessory parts. An accessory part is understood to be a part that is coupled to the grill base (or a structure that is part of or coupled to the grill base) that adds, for example, functionality and/or structural characteristics to the grill. Some examples of accessory parts include carts, cart legs, cart front panels, wheels, control knobs, grill grates, handles, lid panels, lid etchings, and the like. The accessory parts may be tailored to a lifestyle. As such, the accessory parts may take the form of any suitable article associated with the lifestyle including those listed above.

It is worth noting that the concept of a lid panel or lid etching is deemed to fall within the category of an accessory part regardless of whether or not it actually includes attaching something to the lid or not. For example, altering a grill lid by etching it is deemed to be akin to coupling an accessory part to the lid (or, more abstractly, the grill base) based on the concept that the lid has been altered and that the alteration can be considered an accessory part. Such etching may include pictorial representations of articles associated with a lifestyle. Other similar alterations are also considered to fall within the category of attaching an accessory part. Of course, actually adding a panel or sleeve onto the lid itself or adding other parts (such as a handle, for example) also are considered to meet the step of attaching an accessory part to the grill.

### Methods for Target Marketing Grills

At least some embodiments of methods for target marketing grills to a lifestyle generally include providing a grill base having a bowl and a lid, selecting a theme for the grill that is tailored to a lifestyle, fabricating a plurality of accessory parts for the grill that are tailored to the lifestyle, attaching the accessory parts to the grill base, and promoting the grill through marketing channels that are associated with persons having the lifestyle so as to attract sales of the grill to the persons who have the lifestyle. As described above, example accessory parts may include carts, cart legs, cart front panels, wheels, control knobs, grill grates, handles, lid panels, lid etchings, and the like. The accessory parts may be tailored to a lifestyle. As such, the accessory parts may take the form of any suitable article associated with the lifestyle including those listed above.

The step of promoting the grill through marketing channels may include a number of different methods. One example of a step or method for promoting the grill through marketing channels includes advertising. This may include print advertising, television advertising, radio advertising, etc. In addition, the promoting step may also include telemarketing, creating and/or distributing product brochures, etc. Furthermore, promoting may include direct marketing to lifestyle affinity groups (e.g., DUCKS UNLIMITED.®., NWTF.®., RMEF.®., NRA.®., season ticket holders of a particular sports teams, etc.) or to retail outlets typically associated with a particular lifestyle (e.g., CABELA'S.®., BASS PRO SHOPS.®., GANDER MOUNTAIN.®., REI.®., DICK'S SPORTING GOODS.®., stadium shops at a particular sporting venue, golf pro shops, etc.).

### Grills

At least some embodiments of a grill include a grill base including a bowl and a lid and a plurality of accessory parts that are attached to the grill base that are all share a common theme that is tailored to a lifestyle. As described above, example accessory parts may include carts, cart legs, cart front panels, wheels, control knobs, grill grates, handles, lid panels, lid etchings, and the like. The accessory parts may be tailored to a lifestyle. As such, the accessory parts may take the form of any suitable article associated with the lifestyle including those listed above. The grills contemplated include the grills produced by and/or during the methods for manufacturing and methods for target marketing.

### Other Embodiments

In addition to the methods and grills described above, the present invention also includes kits that allow a user to tailor their current grill (or a new grill) to a lifestyle.

These kits may include a package having any suitable number of accessory parts that are all tailored to a particular lifestyle and that can replace similar parts on existing grills. As described above, example accessory parts may include carts, cart legs, cart front panels, wheels, control knobs, grill grates, handles, lid panels, lid etchings, and the like. The accessory parts may be tailored to a lifestyle. As such, the accessory parts may take the form of any suitable article associated with the lifestyle including those listed above. Methods are also contemplated for using such kits or otherwise exchanging parts of a grill with “replacement” accessory parts that are tailored to a lifestyle.

### EXAMPLES

The invention may be further clarified by reference to the following Examples, which serve to exemplify some of the preferred embodiments, and not to limit the invention in any way.

### Example 1

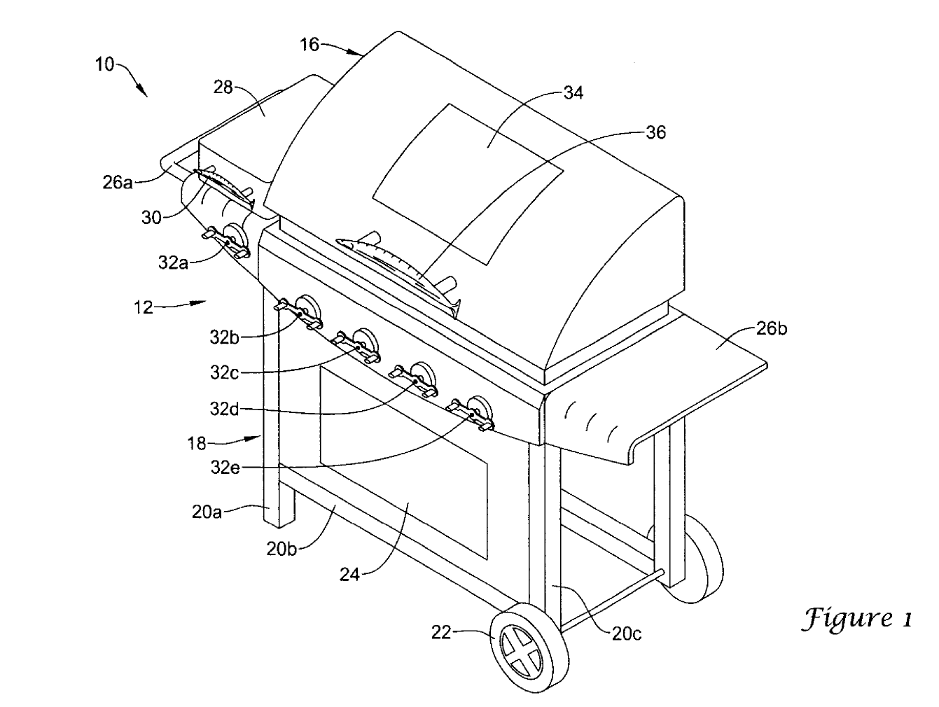

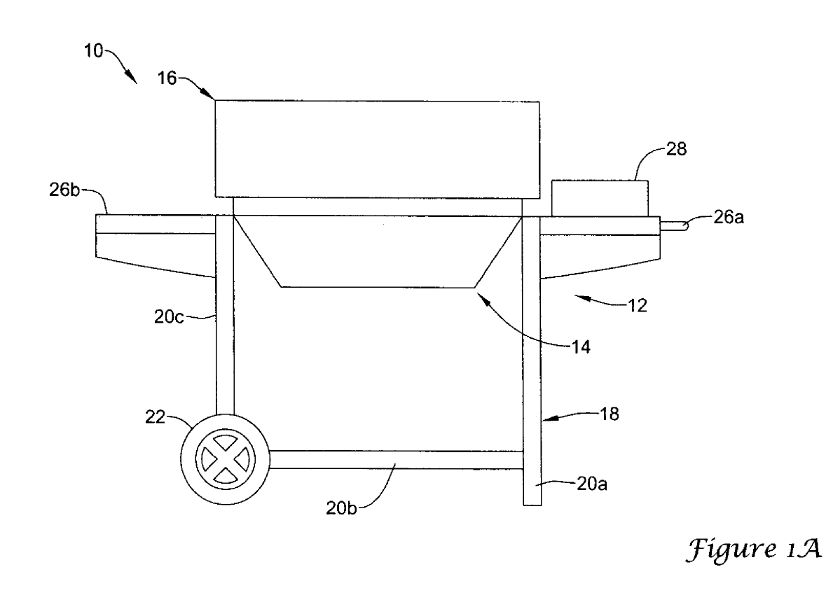

FIG. 1 is an example grill 10 having a grill base 12. Grill base 12 may include a bowl 14 and a lid or lid assembly 16 coupled to bowl 14 (best seen in FIG. 1A). A cart or cart assembly 18 may be coupled to base 12. Cart 18 may include a number of cart legs 20 (identified in FIG. 1 as legs 20a/b/c) and wheels 22. A front panel 24 may be coupled to cart 18 and/or legs 20a/b/c. One or more side tables 26 (identified in FIG. 1 as tables 26a/b) may also be coupled to base 12. On side table 26a, a side burner may be attached (not shown) that can be covered by a side burner lid 28. A handle 30 may be attached to side burner lid 28. One or more control knobs 32 (e.g., knobs 32a/b/c/d/e) may be attached to base 12. Lid 16 may include a front panel region 34 and a handle 36. Handle 36 may be used to raise and lower lid 16.

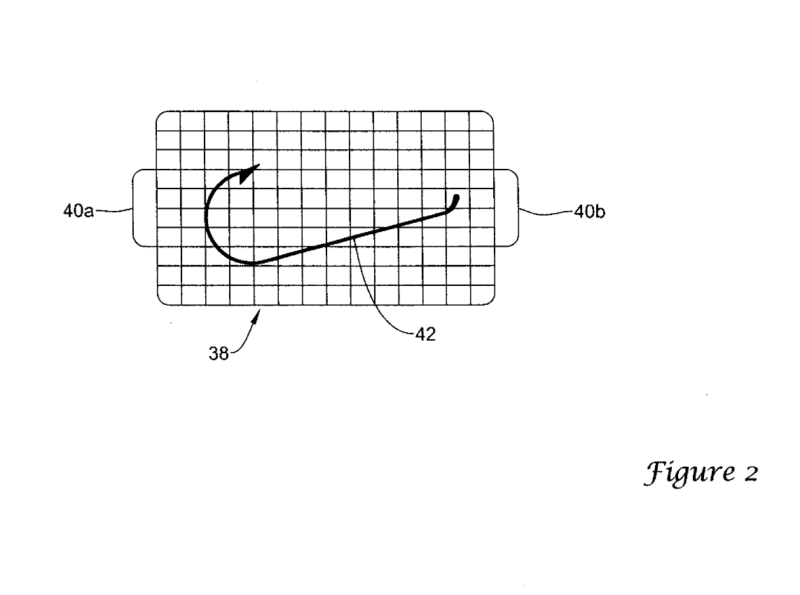

Turning now to FIG. 2, a cooking grate 38 is depicted that can be seated within grill base 12, for example, within bowl 14 as is well know in the grilling art. Grate 38 may include one or more flanged or handle regions 40 (depicted as handles 40a/b) that allow a user to easily remove and install grate 38. Grate 38 may also include a panel region 42. In some embodiments, panel region 42 is located on the top surface of grate 38 so that region 42 can also function as a brand that can form branded sear marks on the food cooked thereon. Alternatively, panel region 42 may be positioned on the bottom surface of grate 38 so as to increase the structural integrity of grate 38 as well as provide a pleasing form that may be tailored to a lifestyle.

A number of the components of grill 10 are accessory parts that are tailored to a lifestyle. In this example, grill 10 is tailored to a fishing lifestyle. With this in mind, handle 30, controls 32a/b/c/d/e, handle 36, and panel region 42 all resemble or take the form of articles associated with fishing. For example, both handles 30/36 take the form of fishing baits. Controls 32a/b/c/d/e all take the form of the handle from a fishing reel. Panel region 42 has the appearance of a fishing hook. It can be readily appreciated that each of these accessory parts shares a common theme and each is tailored to the fishing lifestyle.

In addition to the aforementioned accessory parts, front panel 24 as well as panel 34 on lid 16 may also be accessory parts that are tailored to a fishing lifestyle. For example, in some embodiments, front panel 24 may include one or more fishing or fishing-related illustrations that gives panel 24 a form associated with fishing. In addition, lid panel 34 may comprise one or more lid 16 etchings that take the form of fish scales, for example, or another article associated with the fishing lifestyle. It should be noted that panels 24/34 may have a shape that differs from what is shown in FIG. 1. For example, panels 24/34 may take up a different portion of grill base 12 (e.g., panel 34 may span the front surface of lid 16).

In some embodiments, panels 24/34 comprises panels that are directly added onto grill base 12. For example, panel 24 may be a panel that is affixed to cart 18. Alternatively, panel 24/34 may comprise alterations to existing structural aspects of grill 10. For example, panel 34 may comprise an etched region of lid 16.

The various accessory parts may have a number of alternative forms. For example, handles 30/36 could just as easily take the form of a boat, a fish, a fishing pole, etc. without departing from the spirit of the invention. In addition, knobs 32a/b/c/d/e could also resemble fishing nets, baits, boats, etc. Moreover, other parts shown as being coupled to grill base 12 may, alternatively, be accessory parts that take the form of or resemble articles associated with a fishing lifestyle. For example, legs 20a/b/c, wheels 22, tables 26a/b, or other parts may take the form of fishing-related articles.

In some embodiments, the accessory parts utilized for grill 10 may be the actual articles that they represent. For example, bait handles 30/36 may be actually fishing baits (with the treble hooks removed therefrom) that are mounted onto grill base 12. Moreover, fishing real controls 32a/b/c/d/e may be a portion of actual reels. Alternatively, bait handles 30/36 and controls 32a/b/c/d/e may be molded from plastic, made from wood, made from metal, or made in any other suitable way so as to resemble the actual article.

Methods for manufacturing grill 10 generally include providing grill base 12, fabricating a plurality of accessory parts that are tailored to a lifestyle (in this example a fishing lifestyle) such as those described above, and coupling the accessory parts to grill base 12. The methods for target marketing grill 10 generally include providing a grill base 12, selecting a theme for grill 10 that is tailored to a lifestyle (in this example a fishing lifestyle), fabricating and attaching accessory parts to the grill base that are tailored to the fishing lifestyle, and promoting the grill through marketing channels associated with people having a fishing lifestyle. The promoting step may include, for example, promoting the grill through fishing-related magazines, fishing television programs, through posters at fishing-related retail stores, through fishing product brochures, etc.

### Example 2

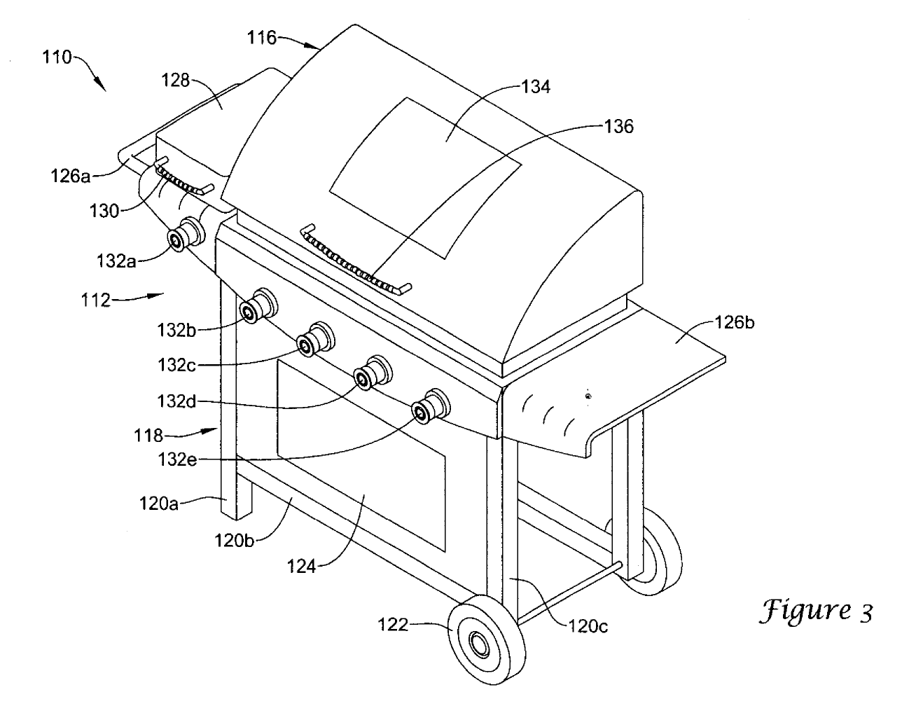

FIG. 3 is another example grill 110 having grill base 112. Grill base 112 may include a bowl (not shown, please refer to bowl 14 as depicted in FIG. 1A, which is the same in form and function) and lid or lid assembly 116 coupled to the bowl. Cart or cart assembly 118 may be coupled to base 112. Cart 118 may include a number of cart legs 120a/b/c and wheels 122. Front panel 124 may be coupled to cart 118 and/or legs 120a/b/c. One or more side tables 126a/b may also be coupled to base 112. On side table 126a, a side burner may be attached (not shown) that can be covered by side burner lid 128. Handle 130 may be attached to side burner lid 128. One or more control knobs 132a/b/c/d/e may be attached to base 112. Lid 116 may include front panel region 134 and handle 136. Handle 136 may be used to raise and lower lid 116.

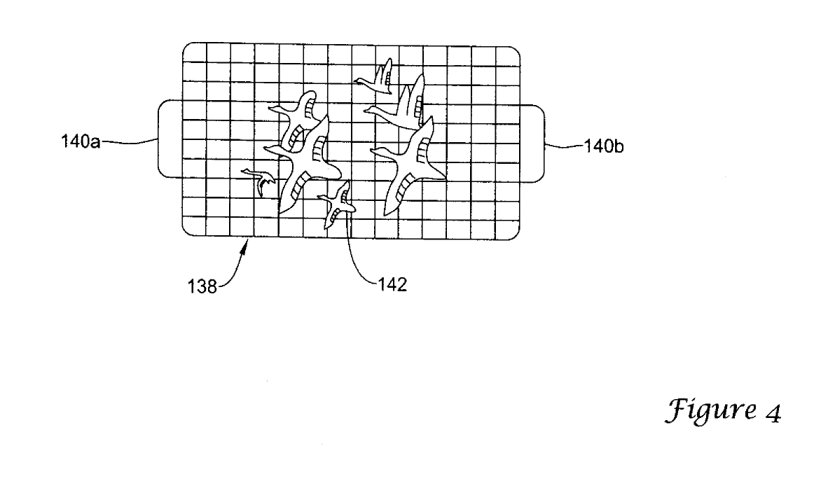

Turning now to FIG. 4, cooking grate 138 is depicted that can be seated within grill base 112, for example, within the bowl as is well know in the grilling art. Grate 138 may include one or more flanged or handle regions 140a/b that allow a user to easily remove and install grate 138. Grate 138 may also include panel region 142. In some embodiments, panel region 142 is located on the top surface of grate 138 so that region 142 can also function as a brand that can form branded sear marks on the food cooked thereon. Alternatively, panel region 142 may be positioned on the bottom surface of grate 138 so as to increase the structural integrity of grate 138 as well as provide a pleasing form that may be tailored to a lifestyle.

A number of the components of grill 110 are accessory parts that are tailored to a lifestyle. In this example, grill 110 is tailored to a duck hunting lifestyle. With this in mind, handle 130, controls 132a/b/c/d/e, handle 136, and panel region 142 all resemble or take the form of articles associated with duck hunting. For example, both handles 130/136 take the form of a lanyard with duck bands. Controls 132a/b/c/d/e all take the form of the handle from a shotgun shells. Panel region 142 has the appearance of ducks (in this example it the appearance of a number of flying ducks). It can be readily appreciated that each of these accessory parts shares a common theme and each is tailored to the duck hunting lifestyle.

In addition to the aforementioned accessory parts, front panel 124 as well as panel 134 on lid 116 may also be accessory parts that are tailored to a duck hunting lifestyle. For example, in some embodiments, front panel 124 may include one or more duck or duck hunting-related illustrations that gives panel 124 a form associated with duck hunting. In addition, lid panel 134 may comprise one or more lid 116 etchings that take the form of ducks, for example, or another article associated with the duck hunting lifestyle. It should be noted that panels 124/134 may have a shape that differs from what is shown in FIG. 3. For example, panels 124/134 may take up a different portion of grill base 112 (e.g., panel 134 may span the front surface of lid 116).

In some embodiments, panels 124/134 comprises panels that are directly added onto grill base 112. For example, panel 124 may be a panel that is affixed to cart 118. Alternatively, panel 124/134 may comprise alterations to existing structural aspects of grill 110. For example, panel 134 may comprise an etched region of lid 116.

The various accessory parts may have a number of alternative forms. For example, handles 130/136 could just as easily take the form of a duck call, duck feathers, a shotgun, a duck, etc. without departing from the spirit of the invention. In addition, knobs 132a/b/c/d/e could also resemble a duck, a duck call, etc. Moreover, other parts shown as being coupled to grill base 112 may, alternatively, be accessory parts that take the form of or resemble articles associated with a duck hunting lifestyle. For example, legs 120a/b/c, wheels 122, tables 126a/b, or other parts may take the form of duck hunting-related articles. This may include legs 120a/b/c bearing a camouflage lanyards with e coloring or design.

In some embodiments, the accessory parts utilized for grill 110 may be the actual articles that they represent. For example, handles 130/136 may be actually crafted from lanyards with duck bands. Moreover, shotgun shell controls 132a/b/c/d/e may be made from actual shotgun shell casings. Alternatively, handles 130/136 and controls 132a/b/c/d/e may be molded from plastic, made from wood, made from metal, or made in any other suitable way so as to resemble the actual article.

Methods for manufacturing grill 110 generally include providing grill base 112, fabricating a plurality of accessory parts that are tailored to a lifestyle (in this example a duck hunting lifestyle) such as those described above, and coupling the accessory parts to grill base 112. The methods for target marketing grill 110 generally include providing a grill base 112, selecting a theme for grill 110 that is tailored to a lifestyle (in this example a duck hunting lifestyle), fabricating and attaching accessory parts to the grill base that are tailored to the duck hunting lifestyle, and promoting the grill through marketing channels associated with people having a duck hunting lifestyle. The promoting step may include, for example, promoting the grill through duck hunting-related magazines, duck hunting television programs, through posters at duck hunting-related retail stores, through duck hunting product brochures, etc.

### Example 3

FIG. 4 is another example grill 210 having grill base 212. Grill base 212 may include a bowl (not shown, please refer to bowl 14 as depicted in FIG. 1A, which is the same in form and function) and lid or lid assembly 216 coupled to the bowl. Cart or cart assembly 218 may be coupled to base 212. Cart 218 may include a number of cart legs 220a/b/c and wheels 222. Front panel 224 may be coupled to cart 218 and/or legs 220a/b/c. One or more side tables 226a/b may also be coupled to base 212. On side table 226a, a side burner may be attached (not shown) that can be covered by side burner lid 228. Handle 230 may be attached to side burner lid 228. One or more control knobs 232a/b/c/d/e may be attached to base 212. Lid 216 may include front panel region 234 and handle 236. Handle 236 may be used to raise and lower lid 216.

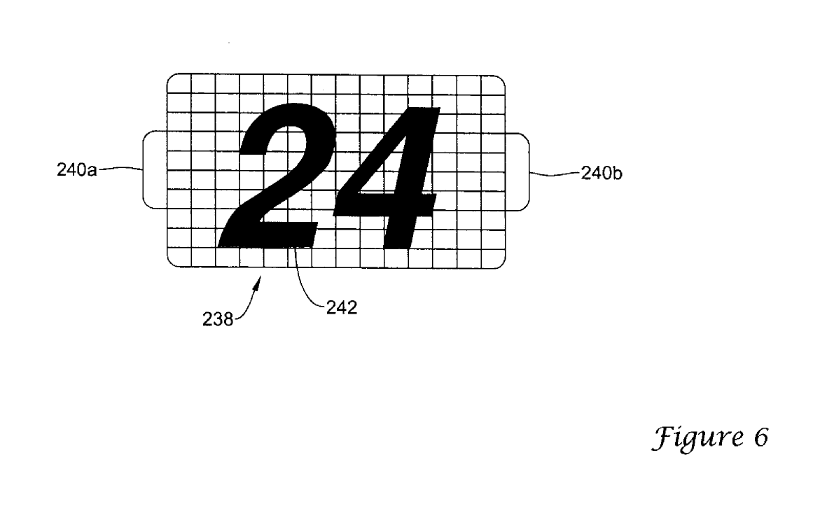

Turning now to FIG. 6, cooking grate 238 is depicted that can be seated within grill base 212, for example, within the bowl as is well know in the grilling art. Grate 238 may include one or more flanged or handle regions 240a/b that allow a user to easily remove and install grate 238. Grate 238 may also include panel region 242. In some embodiments, panel region 242 is located on the top surface of grate 238 so that region 242 can also function as a brand that can form branded sear marks on the food cooked thereon. Alternatively, panel region 242 may be positioned on the bottom surface of grate 238 so as to increase the structural integrity of grate 238 as well as provide a pleasing form that may be tailored to a lifestyle.

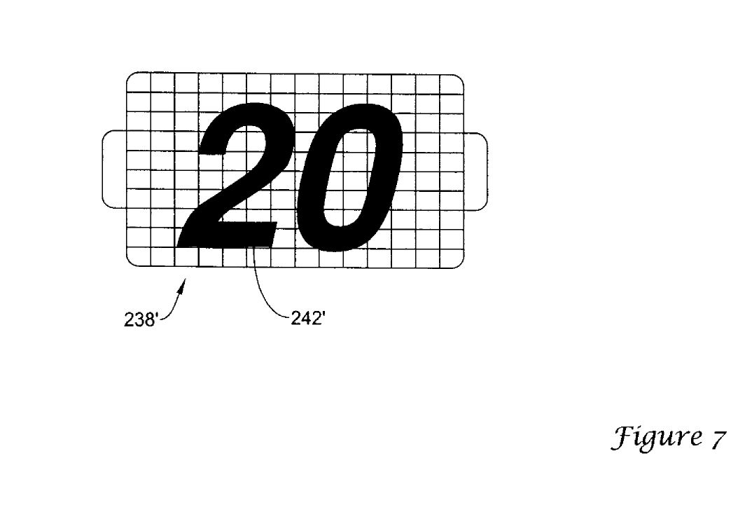

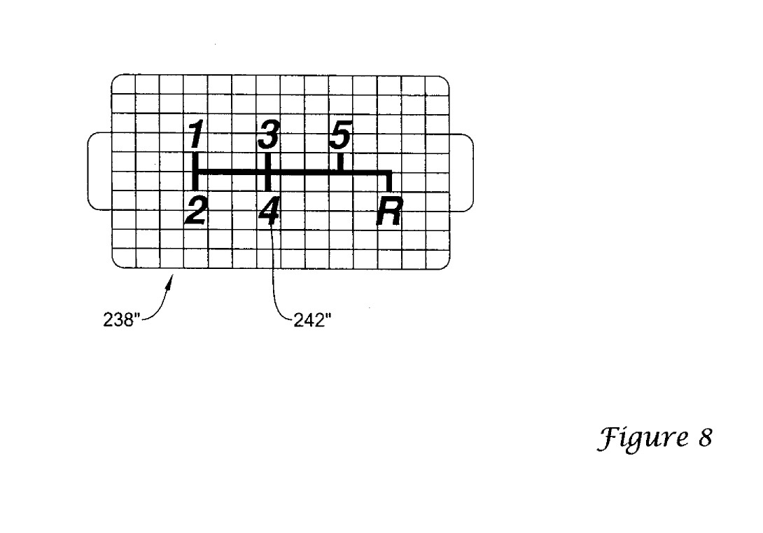

A number of the components of grill 210 are accessory parts that are tailored to a lifestyle. In this example, grill 210 is tailored to an automobile racing lifestyle. With this in mind, handle 230, controls 232a/b/c/d/e, handle 236, and panel region 242 all resemble or take the form of articles associated with automobile racing. For example, both handles 230/236 take the form of a tail pipe. Controls 232a/b/c/d/e all take the form of lug nuts. Panel region 242 has the appearance of a race car number (in this example it the appearance of a NACAR.®. racer Jeff Gordon's number “24”). Alternatively, panel region 242′ of grate 238′ may depict Tony Stewart's number “20” as shown in FIG. 7. Panel region 242″ of grate 238″ may depict the gears of a manual transmission as shown in FIG. 8. It can be readily appreciated that each of these accessory parts shares a common theme and each is tailored to the automobile racing lifestyle.

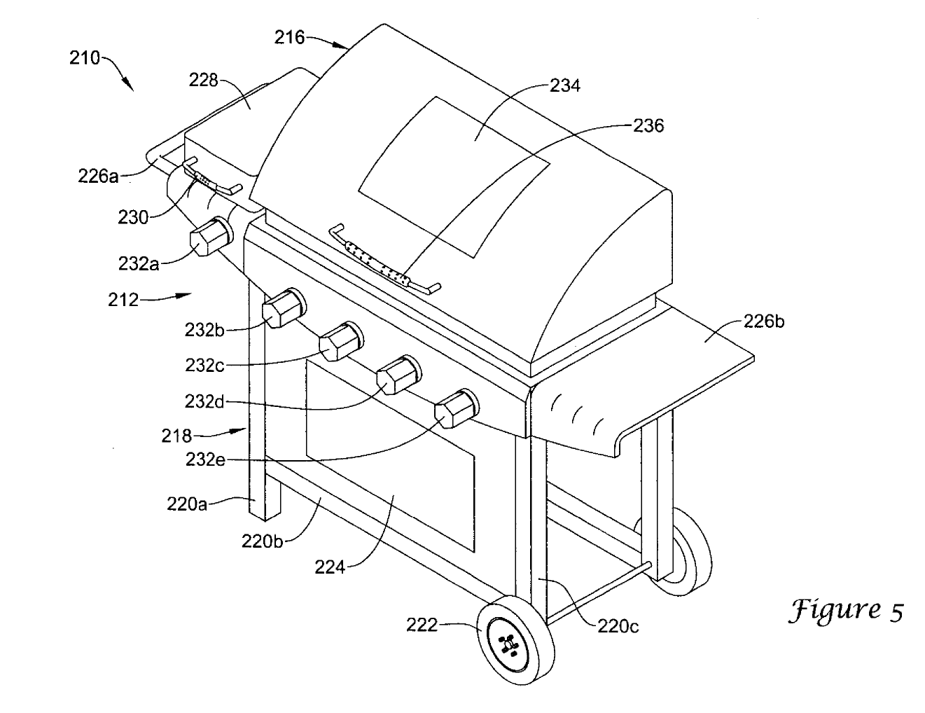

In addition to the aforementioned accessory parts, front panel 224 as well as panel 234 on lid 216 may also be accessory parts that are tailored to an automobile racing lifestyle. For example, in some embodiments, front panel 224 may include one or more automobile racing-related illustrations (e.g., race cars, checkered flags, racing flames, driver signatures, etc.) that gives panel 224 a form associated with automobile racing. In addition, lid panel 234 may comprise one or more lid 216 etchings that take the form of the same or other articles associated with the automobile racing lifestyle. It should be noted that panels 224/234 may have a shape that differs from what is shown in FIG. 5. For example, panels 224/234 may take up a different portion of grill base 212 (e.g., panel 234 may span the front surface of lid 216).

In some embodiments, panels 224/234 comprises panels that are directly added onto grill base 212. For example, panel 224 may be a panel that is affixed to cart 218. Alternatively, panel 224/234 may comprise alterations to existing structural aspects of grill 210. For example, panel 234 may comprise an etched region of lid 216.

The various accessory parts may have a number of alternative forms. For example, handles 230/236 could just as easily take the form of racing cars, steering wheels, racing wheels, manual transmission shifters, etc. without departing from the spirit of the invention. In addition, knobs 232a/b/c/d/e could also resemble racing cars, steering wheels, racing wheels, manual transmission shifters, etc. Moreover, other parts shown as being coupled to grill base 212 may, alternatively, be accessory parts that take the form of or resemble articles associated with an automobile racing lifestyle. For example, legs 220a/b/c, wheels 222 (e.g., racing wheels), tables 226a/b, or other parts may take the form of automobile racing-related articles. This may also include modifications to a grill temperature gauge (not shown) that may be coupled to lid 216 so that it resembles a speedometer, tachometer, or fuel gauge.

In some embodiments, the accessory parts utilized for grill 210 may be the actual articles that they represent. For example, handles 230/236 may be actual portions of an automobile tail pipe. Moreover, lug nut controls 232a/b/c/d/e may be made from actual lug nuts. Alternatively, handles 230/236 and controls 232a/b/c/d/e may be molded from plastic, made from wood, made from metal, or made in any other suitable way so as to resemble the actual article.

Methods for manufacturing grill 210 generally include providing grill base 212, fabricating a plurality of accessory parts that are tailored to a lifestyle (in this example an automobile racing lifestyle) such as those described above, and coupling the accessory parts to grill base 212. The methods for target marketing grill 210 generally include providing a grill base 212, selecting a theme for grill 210 that is tailored to a lifestyle (in this example an automobile racing lifestyle), fabricating and attaching accessory parts to the grill base that are tailored to the automobile racing lifestyle, and promoting the grill through marketing channels associated with people having an automobile racing lifestyle. The promoting step may include, for example, promoting the grill through racing-related magazines, racing television programs, through posters at racing-related retail stores, through racing product brochures, etc.

### Example 4

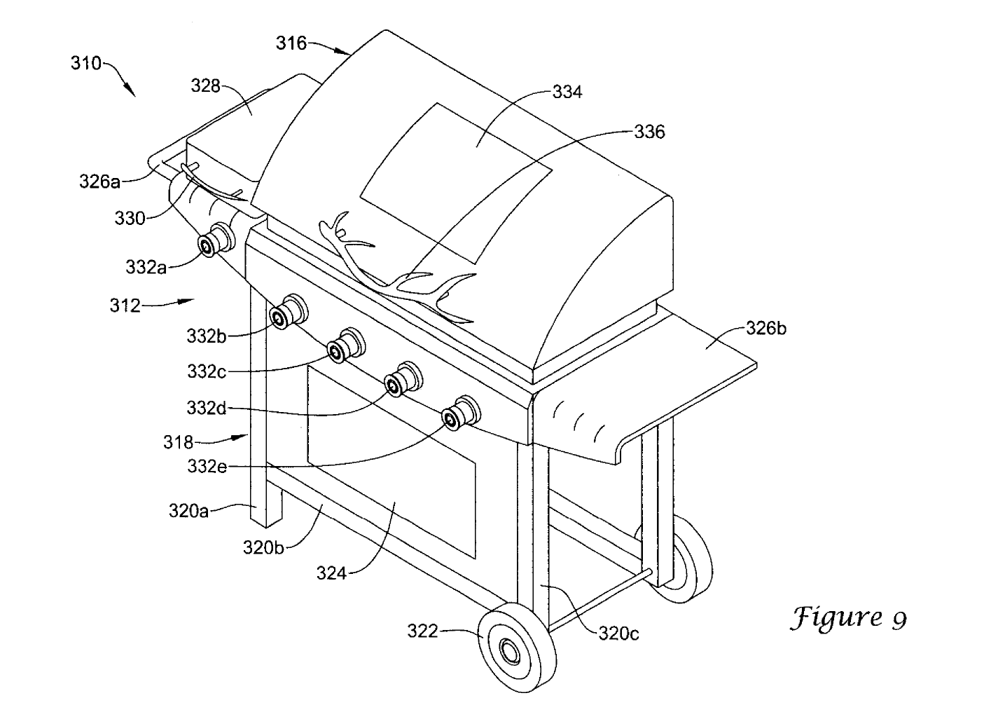

FIG. 9 is another example grill 310 having grill base 312. Grill base 312 may include a bowl (not shown, please refer to bowl 14 as depicted in FIG. 1A, which is the same in form and function) and lid or lid assembly 316 coupled to the bowl. Cart or cart assembly 318 may be coupled to base 312. Cart 318 may include a number of cart legs 320a/b/c and wheels 322. Front panel 324 may be coupled to cart 318 and/or legs 320a/b/c. One or more side tables 326a/b may also be coupled to base 312. On side table 326a, a side burner may be attached (not shown) that can be covered by side burner lid 328. Handle 330 may be attached to side burner lid 328. One or more control knobs 332a/b/c/d/e may be attached to base 312. Lid 316 may include front panel region 334 and handle 336. Handle 336 may be used to raise and lower lid 316.

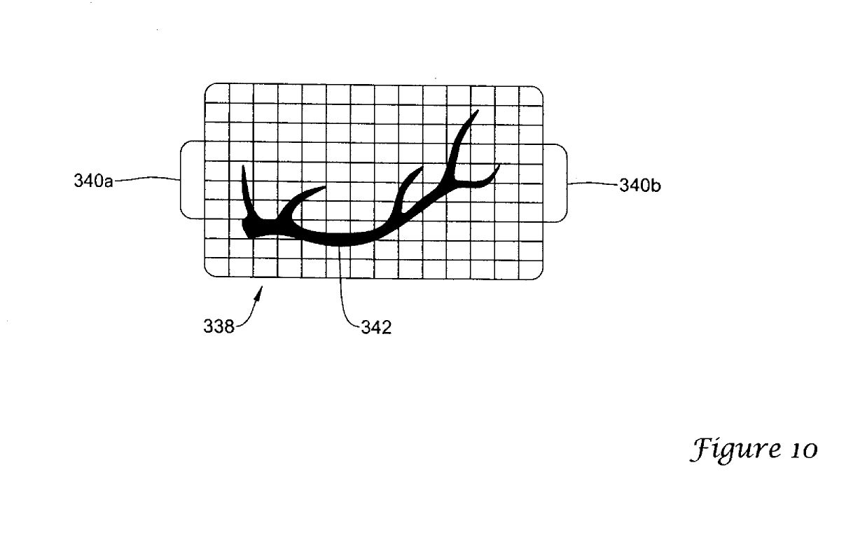

Turning now to FIG. 10, cooking grate 338 is depicted that can be seated within grill base 312, for example, within the bowl as is well know in the grilling art. Grate 338 may include one or more flanged or handle regions 340a/b that allow a user to easily remove and install grate 338. Grate 338 may also include panel region 342. In some embodiments, panel region 342 is located on the top surface of grate 338 so that region 342 can also function as a brand that can form branded sear marks on the food cooked thereon. Alternatively, panel region 342 may be positioned on the bottom surface of grate 338 so as to increase the structural integrity of grate 338 as well as provide a pleasing form that may be tailored to a lifestyle.

A number of the components of grill 310 are accessory parts that are tailored to a lifestyle. In this example, grill 310 is tailored to a hunting lifestyle (e.g., a deer and/or elk hunting lifestyle). With this in mind, handle 330, controls 332a/b/c/d/e, handle 336, and panel region 342 all resemble or take the form of articles associated with hunting. For example, both handles 330/336 take the form of elk or deer antlers. Controls 332a/b/c/d/e all take the form of rifle shell casing. Panel region 342 has the appearance of a hunting related article such as a hunting cabin, deer, elk, etc. It can be readily appreciated that each of these accessory parts shares a common theme and each is tailored to the hunting lifestyle.

In addition to the aforementioned accessory parts, front panel 324 as well as panel 334 on lid 316 may also be accessory parts that are tailored to a hunting lifestyle. For example, in some embodiments, front panel 324 may include one or more hunting-related illustrations (e.g., deer, elk, cabins, etc.) that gives panel 324 a form associated with automobile racing. In addition, lid panel 334 may comprise one or more lid 316 etchings that take the form of the same or other articles associated with the hunting lifestyle. It should be noted that panels 324/334 may have a shape that differs from what is shown in FIG. 9. For example, panels 324/334 may take up a different portion of grill base 312 (e.g., panel 334 may span the front surface of lid 316).

In some embodiments, panels 324/334 comprises panels that are directly added onto grill base 312. For example, panel 324 may be a panel that is affixed to cart 318. Alternatively, panel 324/334 may comprise alterations to existing structural aspects of grill 310. For example, panel 334 may comprise an etched region of lid 316.

The various accessory parts may have a number of alternative forms. For example, handles 330/336 could just as easily take the form of deer, elk, hunting rifles, etc. without departing from the spirit of the invention. In addition, knobs 332a/b/c/d/e could also resemble deer, elk, hunting rifles, etc. Moreover, other parts shown as being coupled to grill base 312 may, alternatively, be accessory parts that take the form of or resemble articles associated with a hunting lifestyle. For example, legs 320a/b/c, wheels 322, tables 326a/b, or other parts may take the form of hunting articles. This may include modifications to wheels 322 so that they resemble the face plate of a rifle shell casing.

In some embodiments, the accessory parts utilized for grill 310 may be the actual articles that they represent. For example, handles 330/336 may be actual antlers. Moreover, shell casing controls 332a/b/c/d/e may be made from actual shell casings. Alternatively, handles 330/336 and controls 332a/b/c/d/e may be molded from plastic, made from wood, made from metal, or made in any other suitable way so as to resemble the actual article.

Methods for manufacturing grill 310 generally include providing grill base 312, fabricating a plurality of accessory parts that are tailored to a lifestyle (in this example a hunting lifestyle) such as those described above, and coupling the accessory parts to grill base 312. The methods for target marketing grill 310 generally include providing a grill base 312, selecting a theme for grill 310 that is tailored to a lifestyle (in this example a hunting lifestyle), fabricating and attaching accessory parts to the grill base that are tailored to the hunting lifestyle, and promoting the grill through marketing channels associated with people having a hunting lifestyle. The promoting step may include, for example, promoting the grill through hunting-related magazines, hunting television programs, through posters at hunting-related retail stores, through hunting product brochures, etc.

### Example 5

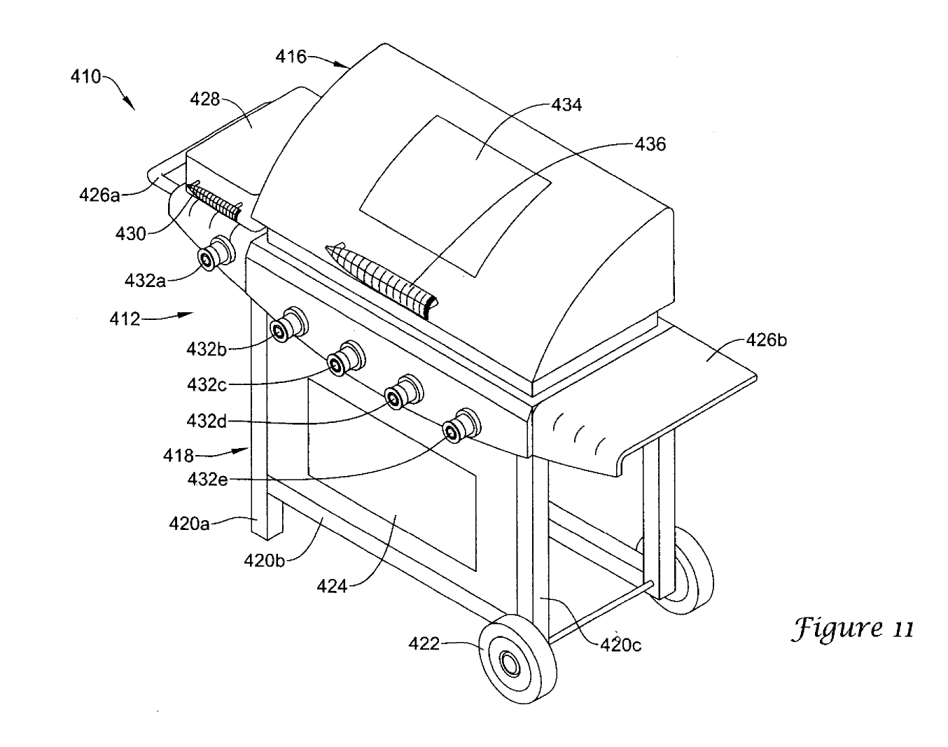

FIG. 11 is another example grill 410 having grill base 412. Grill base 412 may include a bowl (not shown, please refer to bowl 14 as depicted in FIG. 1A, which is the same in form and function) and lid or lid assembly 416 coupled to the bowl. Cart or cart assembly 418 may be coupled to base 412. Cart 418 may include a number of cart legs 420a/b/c and wheels 422. Front panel 424 may be coupled to cart 418 and/or legs 420a/b/c. One or more side tables 426a/b may also be coupled to base 412. On side table 426a, a side burner may be attached (not shown) that can be covered by side burner lid 428. Handle 430 may be attached to side burner lid 428. One or more control knobs 432a/b/c/d/e may be attached to base 412. Lid 416 may include front panel region 434 and handle 436. Handle 436 may be used to raise and lower lid 416.

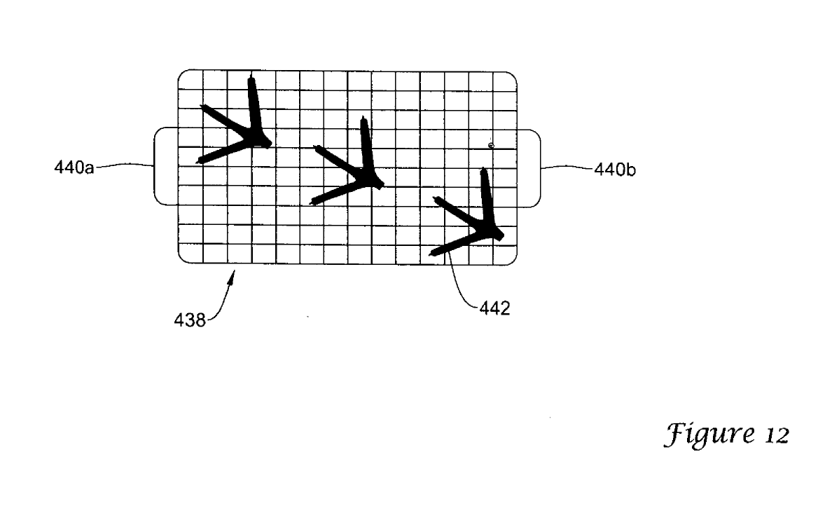

Turning now to FIG. 12 cooking grate 438 is depicted that can be seated within grill base 412, for example, within the bowl as is well know in the grilling art. Grate 438 may include one or more flanged or handle regions 440a/b that allow a user to easily remove and install grate 438. Grate 438 may also include panel region 442. In some embodiments, panel region 442 is located on the top surface of grate 438 so that region 442 can also function as a brand that can form branded sear marks on the food cooked thereon. Alternatively, panel region 442 may be positioned on the bottom surface of grate 438 so as to increase the structural integrity of grate 438 as well as provide a pleasing form that may be tailored to a lifestyle.

A number of the components of grill 410 are accessory parts that are tailored to a lifestyle. In this example, grill 410 is tailored to a turkey hunting lifestyle. With this in mind, handle 430, controls 432a/b/c/d/e, handle 436, and panel region 442 all resemble or take the form of articles associated with turkey hunting. For example, both handles 430/436 take the form of turkey feathers. Controls 432a/b/c/d/e all take the form of shotgun shell casing. Panel region 442 has the appearance of a turkey hunting related article such as turkey tracks, a hunting cabin, turkeys, etc. It can be readily appreciated that each of these accessory parts shares a common theme and each is tailored to the turkey hunting lifestyle.

In addition to the aforementioned accessory parts, front panel 424 as well as panel 434 on lid 416 may also be accessory parts that are tailored to a turkey hunting lifestyle. For example, in some embodiments, front panel 424 may include one or more turkey hunting-related illustrations (e.g., turkeys, turkey features, turkey feet, turkey tracks, etc.) that gives panel 424 a form associated with turkey hunting. In addition, lid panel 434 may comprise one or more lid 416 etchings that take the form of the same or other articles associated with the turkey hunting lifestyle. It should be noted that panels 424/434 may have a shape that differs from what is shown in FIG. 11. For example, panels 424/434 may take up a different portion of grill base 412 (e.g., panel 434 may span the front surface of lid 416).

In some embodiments, panels 424/434 comprises panels that are directly added onto grill base 412. For example, panel 424 may be a panel that is affixed to cart 418. Alternatively, panel 424/434 may comprise alterations to existing structural aspects of grill 410. For example, panel 434 may comprise an etched region of lid 416.

The various accessory parts may have a number of alternative forms. For example, handles 430/436 could just as easily take the form of turkeys, turkey calls, lanyards having turkey bands, etc. without departing from the spirit of the invention. In addition, knobs 432a/b/c/d/e could also resemble turkeys, turkey calls, lanyards having turkey bands, etc. Moreover, other parts shown as being coupled to grill base 412 may, alternatively, be accessory parts that take the form of or resemble articles associated with a turkey hunting lifestyle. For example, legs 420a/b/c, wheels 422, tables 426a/b, or other parts may take the form of turkey hunting articles. This may include modifications to wheels 422 so that they resemble the face plate of a shotgun shell casing.

In some embodiments, the accessory parts utilized for grill 410 may be the actual articles that they represent. For example, handles 430/436 may be or include actual turkey features. Moreover, shell casing controls 432a/b/c/d/e may be made from actual shell casings. Alternatively, handles 430/436 and controls 432a/b/c/d/e may be molded from plastic, made from wood, made from metal, or made in any other suitable way so as to resemble the actual article.

Methods for manufacturing grill 410 generally include providing grill base 412, fabricating a plurality of accessory parts that are tailored to a lifestyle (in this example a turkey hunting lifestyle) such as those described above, and coupling the accessory parts to grill base 412. The methods for target marketing grill 410 generally include providing a grill base 412, selecting a theme for grill 410 that is tailored to a lifestyle (in this example a turkey hunting lifestyle), fabricating and attaching accessory parts to the grill base that are tailored to the turkey hunting lifestyle, and promoting the grill through marketing channels associated with people having a turkey hunting lifestyle. The promoting step may include, for example, promoting the grill through turkey hunting-related magazines, turkey hunting television programs, through posters at turkey hunting-related retail stores, through turkey hunting product brochures, etc.

### Example 6

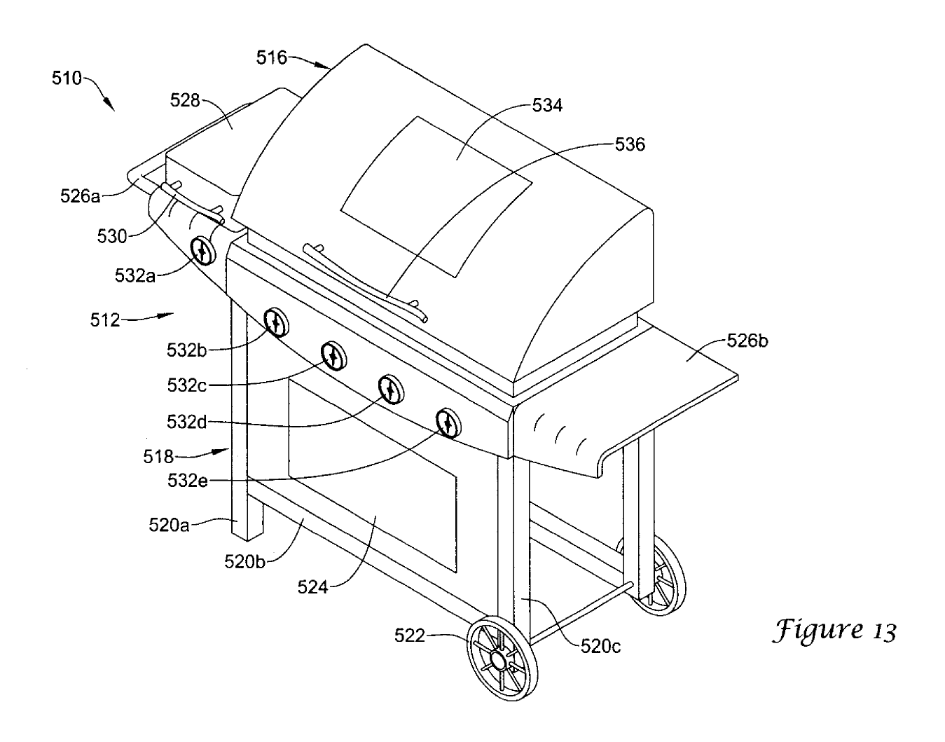

FIG. 13 is another example grill 510 having grill base 512. Grill base 512 may include a bowl (not shown, please refer to bowl 14 as depicted in FIG. 1A, which is the same in form and function) and lid or lid assembly 516 coupled to the bowl. Cart or cart assembly 518 may be coupled to base 512. Cart 518 may include a number of cart legs 520a/b/c and wheels 522. Front panel 524 may be coupled to cart 518 and/or legs 520a/b/c. One or more side tables 526a/b may also be coupled to base 512. On side table 526a, a side burner may be attached (not shown) that can be covered by side burner lid 528. Handle 530 may be attached to side burner lid 528. One or more control knobs 532a/b/c/d/e may be attached to base 512. Lid 516 may include front panel region 534 and handle 536. Handle 536 may be used to raise and lower lid 516.

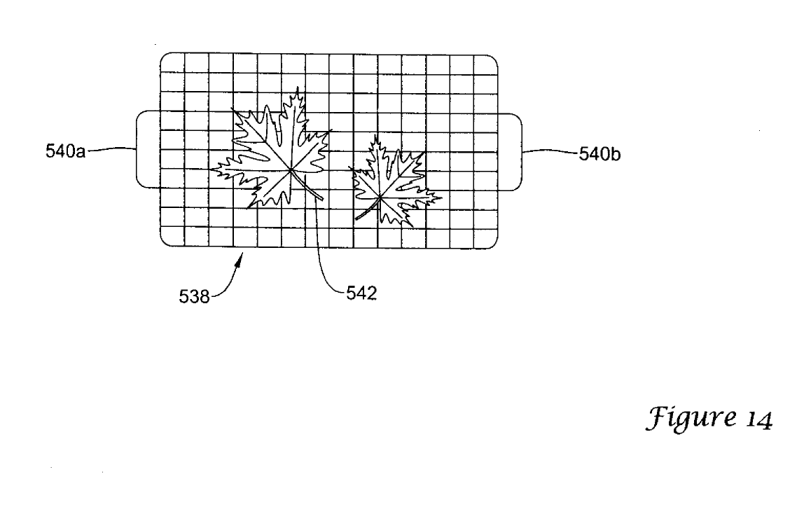

Turning now to FIG. 14 cooking grate 538 is depicted that can be seated within grill base 512, for example, within the bowl as is well know in the grilling art. Grate 538 may include one or more flanged or handle regions 540a/b that allow a user to easily remove and install grate 538. Grate 538 may also include panel region 542. In some embodiments, panel region 542 is located on the top surface of grate 538 so that region 542 can also function as a brand that can form branded sear marks on the food cooked thereon. Alternatively, panel region 542 may be positioned on the bottom surface of grate 538 so as to increase the structural integrity of grate 538 as well as provide a pleasing form that may be tailored to a lifestyle.

A number of the components of grill 510 are accessory parts that are tailored to a lifestyle. In this example, grill 510 is tailored to an outdoors lifestyle. With this in mind, handle 530, controls 532a/b/c/d/e, handle 536, and panel region 542 all resemble or take the form of articles associated with the outdoors. For example, both handles 530/536 take the form of sticks or tree branches. Controls 532a/b/c/d/e all take the form of compasses. Panel region 542 has the appearance of an outdoors related article such as leaves, a cabin, oars, etc. It can be readily appreciated that each of these accessory parts shares a common theme and each is tailored to the outdoors lifestyle.

In addition to the aforementioned accessory parts, front panel 524 as well as panel 534 on lid 516 may also be accessory parts that are tailored to an outdoors lifestyle. For example, in some embodiments, front panel 524 may include one or more outdoors-related illustrations (e.g., cabins, the woods, leaves, maps, etc.) that gives panel 524 a form associated with the outdoors. In addition, lid panel 534 may comprise one or more lid 516 etchings that take the form of the same or other articles associated with the outdoors lifestyle. It should be noted that panels 524/534 may have a shape that differs from what is shown in FIG. 13. For example, panels 524/534 may take up a different portion of grill base 512 (e.g., panel 534 may span the front surface of lid 516).

In some embodiments, panels 524/534 comprises panels that are directly added onto grill base 512. For example, panel 524 may be a panel that is affixed to cart 518. Alternatively, panel 524/534 may comprise alterations to existing structural aspects of grill 510. For example, panel 534 may comprise an etched region of lid 516.

The various accessory parts may have a number of alternative forms. For example, handles 530/536 could just as easily take the form of canoes, canoe paddles, etc. without departing from the spirit of the invention. In addition, knobs 532a/b/c/d/e could also resemble canoes, canoe paddles, etc. Moreover, other parts shown as being coupled to grill base 512 may, alternatively, be accessory parts that take the form of or resemble articles associated with an outdoors lifestyle. For example, legs 520a/b/c, wheels 522, tables 526a/b, or other parts may take the form of outdoors articles. This may include modifications to wheels 522 so that they resemble wagon wheels.

In some embodiments, the accessory parts utilized for grill 510 may be the actual articles that they represent. For example, handles 530/536 may be or include actual tree branches. Moreover, compass controls 532a/b/c/d/e may be made from compasses. Alternatively, handles 530/536 and controls 532a/b/c/d/e may be molded from plastic, made from wood, made from metal, or made in any other suitable way so as to resemble the actual article.

Methods for manufacturing grill 510 generally include providing grill base 512, fabricating a plurality of accessory parts that are tailored to a lifestyle (in this example an outdoors lifestyle) such as those described above, and coupling the accessory parts to grill base 512. The methods for target marketing grill 510 generally include providing a grill base 512, selecting a theme for grill 510 that is tailored to a lifestyle (in this example an outdoors lifestyle), fabricating and attaching accessory parts to the grill base that are tailored to the outdoors lifestyle, and promoting the grill through marketing channels associated with people having an outdoors lifestyle. The promoting step may include, for example, promoting the grill through outdoors magazines, outdoors television programs, through posters at outdoors-related retail stores, through outdoors product brochures, etc.

### Example 7

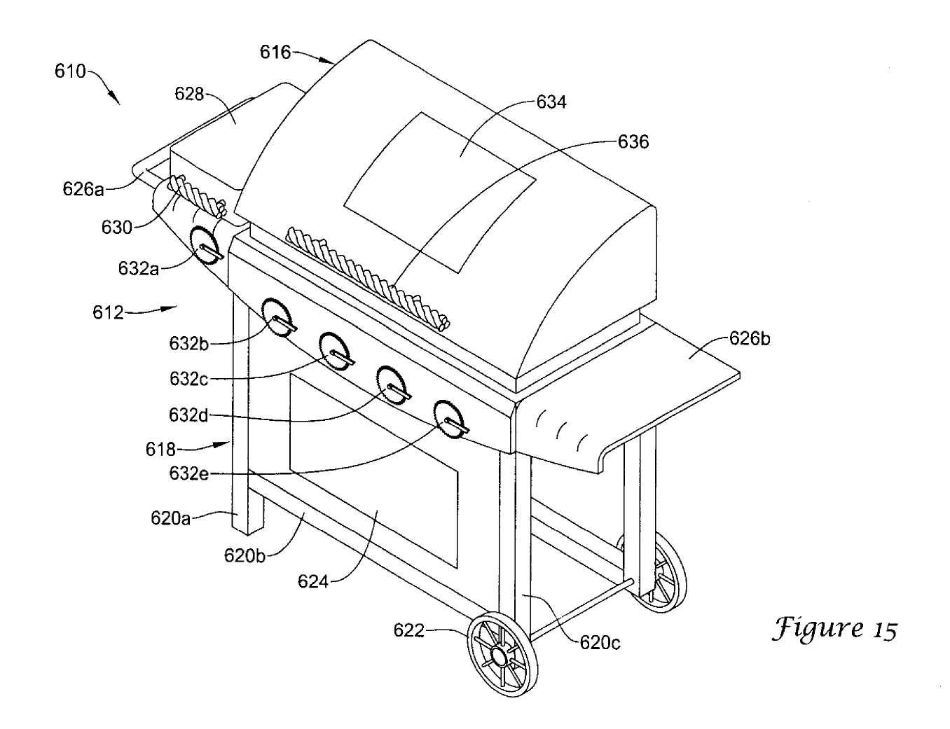

FIG. 15 is another example grill 610 having grill base 612. Grill base 612 may include a bowl (not shown, please refer to bowl 14 as depicted in FIG. 1A, which is the same in form and function) and lid or lid assembly 616 coupled to the bowl. Cart or cart assembly 618 may be coupled to base 612. Cart 618 may include a number of cart legs 620a/b/c and wheels 622. Front panel 624 may be coupled to cart 618 and/or legs 620a/b/c. One or more side tables 626a/b may also be coupled to base 612. On side table 626a, a side burner may be attached (not shown) that can be covered by side burner lid 628. Handle 630 may be attached to side burner lid 628. One or more control knobs 632a/b/c/d/e may be attached to base 612. Lid 616 may include front panel region 634 and handle 636. Handle 636 may be used to raise and lower lid 616.

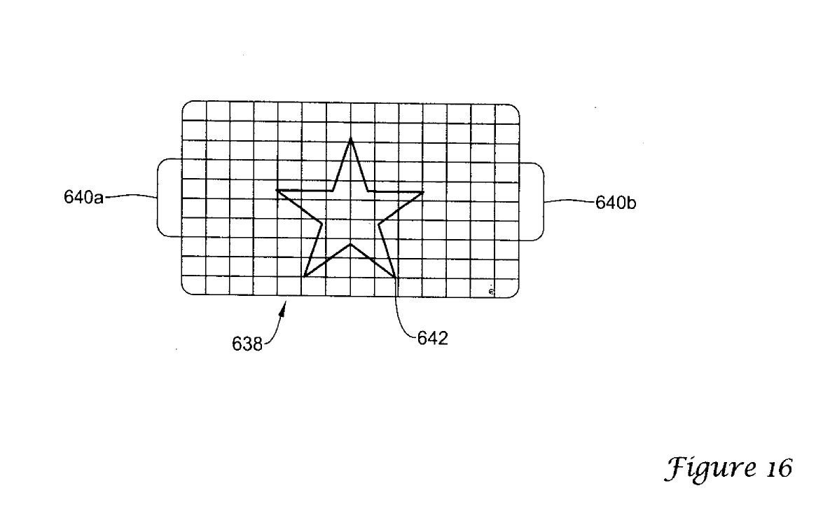

Turning now to FIG. 16 cooking grate 638 is depicted that can be seated within grill base 612, for example, within the bowl as is well know in the grilling art. Grate 638 may include one or more flanged or handle regions 640a/b that allow a user to easily remove and install grate 638. Grate 638 may also include panel region 642. In some embodiments, panel region 642 is located on the top surface of grate 638 so that region 642 can also function as a brand that can form branded sear marks on the food cooked thereon. Alternatively, panel region 642 may be positioned on the bottom surface of grate 638 so as to increase the structural integrity of grate 638 as well as provide a pleasing form that may be tailored to a lifestyle.

A number of the components of grill 610 are accessory parts that are tailored to a lifestyle. In this example, grill 610 is tailored to a cowboy lifestyle. With this in mind, handle 630, controls 632a/b/c/d/e, handle 636, and panel region 642 all resemble or take the form of articles associated with cowboys. For example, both handles 630/636 take the form of braided ropes. Controls 632a/b/c/d/e all take the form of spurs. Panel region 642 has the appearance of a cowboy related article such as a Texas-style star, horseshoe, a steer skull, horses, etc. It can be readily appreciated that each of these accessory parts shares a common theme and each is tailored to the cowboy lifestyle.

In addition to the aforementioned accessory parts, front panel 624 as well as panel 634 on lid 616 may also be accessory parts that are tailored to a cowboy lifestyle. For example, in some embodiments, front panel 624 may include one or more cowboy-related illustrations (e.g., horseshoes, steer skulls, horses, etc.) that gives panel 624 a form associated with cowboys. In addition, lid panel 634 may comprise one or more lid 616 etchings that take the form of the same or other articles associated with the cowboy lifestyle. It should be noted that panels 624/634 may have a shape that differs from what is shown in FIG. 15. For example, panels 624/634 may take up a different portion of grill base 612 (e.g., panel 634 may span the front surface of lid 616).

In some embodiments, panels 624/634 comprises panels that are directly added onto grill base 612. For example, panel 624 may be a panel that is affixed to cart 618. Alternatively, panel 624/634 may comprise alterations to existing structural aspects of grill 610. For example, panel 634 may comprise an etched region of lid 616.

The various accessory parts may have a number of alternative forms. For example, handles 630/636 could just as easily take the form of horseshoes, spurs, etc.

without departing from the spirit of the invention. In addition, knobs 632a/b/c/d/e could also resemble cowboy hats, cowboy boots, etc. Moreover, other parts shown as being coupled to grill base 612 may, alternatively, be accessory parts that take the form of or resemble articles associated with a cowboy lifestyle. For example, legs 620a/b/c, wheels 622, tables 626a/b, or other parts may take the form of cowboy articles. This may include modifications to wheels 622 so that they resemble wagon wheels.

In some embodiments, the accessory parts utilized for grill 610 may be the actual articles that they represent. For example, handles 630/636 may be or include actual ropes. Moreover, spurs controls 632a/b/c/d/e may be made from spurs. Alternatively, handles 630/636 and controls 632a/b/c/d/e may be molded from plastic, made from wood, made from metal, or made in any other suitable way so as to resemble the actual article.

Methods for manufacturing grill 610 generally include providing grill base 612, fabricating a plurality of accessory parts that are tailored to a lifestyle (in this example a cowboy lifestyle) such as those described above, and coupling the accessory parts to grill base 612. The methods for target marketing grill 610 generally include providing a grill base 612, selecting a theme for grill 610 that is tailored to a lifestyle (in this example a cowboy lifestyle), fabricating and attaching accessory parts to the grill base that are tailored to the cowboy lifestyle, and promoting the grill through marketing channels associated with people having a cowboy lifestyle. The promoting step may include, for example, promoting the grill through cowboy magazines, cowboy television programs, through posters at cowboy-related retail stores, through cowboy product brochures, etc.

### Example 8

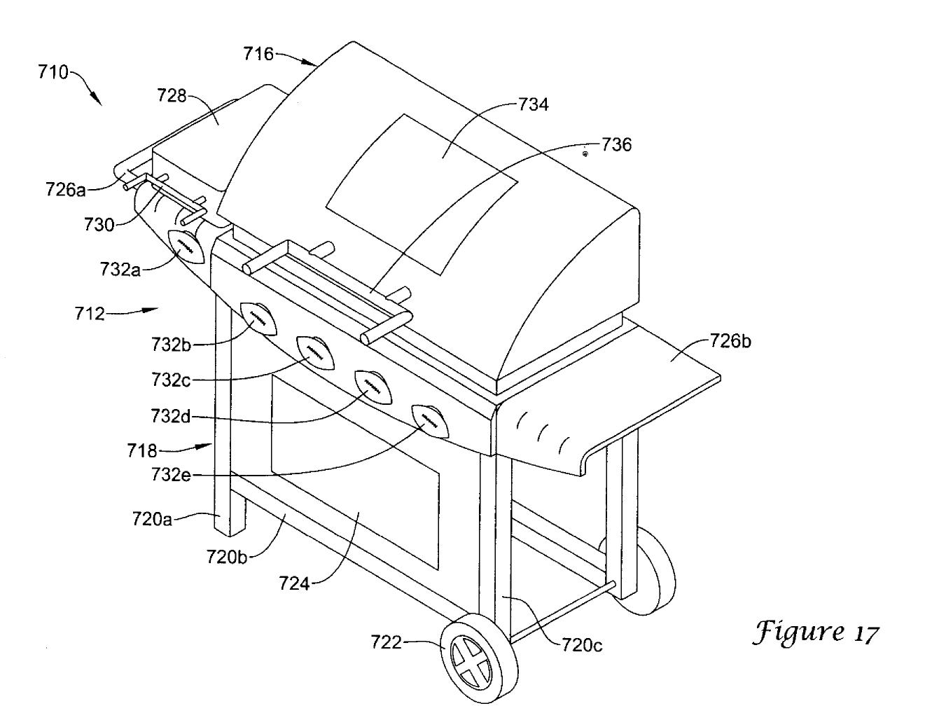

FIG. 17 is another example grill 710 having grill base 712. Grill base 712 may include a bowl (not shown, please refer to bowl 14 as depicted in FIG. 1A, which is the same in form and function) and lid or lid assembly 716 coupled to the bowl. Cart or cart assembly 718 may be coupled to base 712. Cart 718 may include a number of cart legs 720a/b/c and wheels 722. Front panel 724 may be coupled to cart 718 and/or legs 720a/b/c. One or more side tables 726a/b may also be coupled to base 712. On side table 726a, a side burner may be attached (not shown) that can be covered by side burner lid 728. Handle 730 may be attached to side burner lid 728. One or more control knobs 732a/b/c/d/e may be attached to base 712. Lid 716 may include front panel region 734 and handle 736. Handle 736 may be used to raise and lower lid 716.

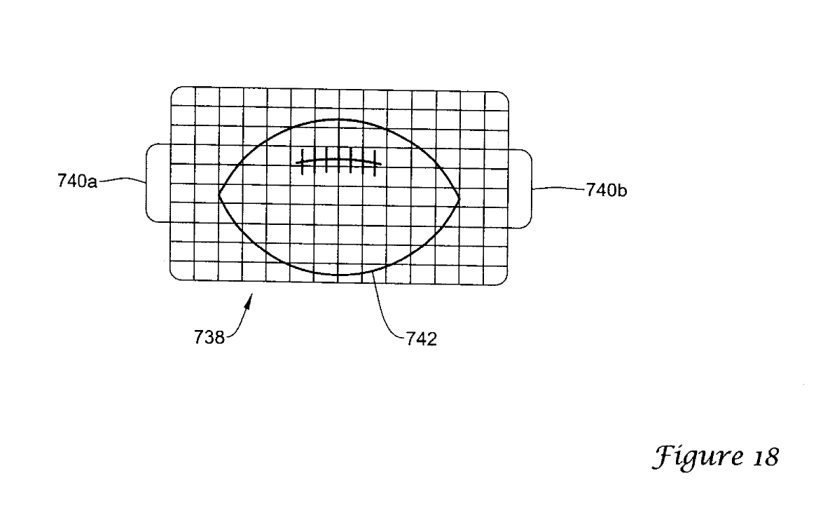

Turning now to FIG. 18 cooking grate 738 is depicted that can be seated within grill base 712, for example, within the bowl as is well know in the grilling art. Grate 738 may include one or more flanged or handle regions 740a/b that allow a user to easily remove and install grate 738. Grate 738 may also include panel region 742. In some embodiments, panel region 742 is located on the top surface of grate 738 so that region 742 can also function as a brand that can form branded sear marks on the food cooked thereon. Alternatively, panel region 742 may be positioned on the bottom surface of grate 738 so as to increase the structural integrity of grate 738 as well as provide a pleasing form that may be tailored to a lifestyle.

A number of the components of grill 710 are accessory parts that are tailored to a lifestyle. In this example, grill 710 is tailored to a football lifestyle. With this in mind, handle 730, controls 732a/b/c/d/e, handle 736, and panel region 742 all resemble or take the form of articles associated with football. For example, both handles 730/736 take the form of football goal posts. Controls 732a/b/c/d/e all take the form of footballs. Panel region 742 has the appearance of a football related article such as a football, a football field, a scoreboard, etc. It can be readily appreciated that each of these accessory parts shares a common theme and each is tailored to the football lifestyle.

In addition to the aforementioned accessory parts, front panel 724 as well as panel 734 on lid 716 may also be accessory parts that are tailored to a football lifestyle. For example, in some embodiments, front panel 724 may include one or more football-related illustrations (e.g., a football, a football field, a scoreboard, etc.) that gives panel 724 a form associated with football. In addition, lid panel 734 may comprise one or more lid 716 etchings that take the form of the same or other articles associated with the football lifestyle. It should be noted that panels 724/734 may have a shape that differs from what is shown in FIG. 17. For example, panels 724/734 may take up a different portion of grill base 712 (e.g., panel 734 may span the front surface of lid 716).

In some embodiments, panels 724/734 comprises panels that are directly added onto grill base 712. For example, panel 724 may be a panel that is affixed to cart 718. Alternatively, panel 724/734 may comprise alterations to existing structural aspects of grill 710. For example, panel 734 may comprise an etched region of lid 716.

The various accessory parts may have a number of alternative forms. For example, handles 730/736 could just as easily take the form of footballs, football helmets, football players, etc. without departing from the spirit of the invention. In addition, knobs 732a/b/c/d/e could also resemble football helmets, football players, etc. Moreover, other parts shown as being coupled to grill base 712 may, alternatively, be accessory parts that take the form of or resemble articles associated with a football lifestyle. For example, legs 720a/b/c, wheels 722, tables 726a/b, or other parts may take the form of football articles.

In some embodiments, the accessory parts utilized for grill 710 may be the actual articles that they represent. For example, handles 730/736 may be or include actual portions of football goal posts. Moreover, football controls 732a/b/c/d/e may be made from footballs (albeit small footballs). Alternatively, handles 730/736 and controls 732a/b/c/d/e may be molded from plastic, made from wood, made from metal, or made in any other suitable way so as to resemble the actual article.

Methods for manufacturing grill 710 generally include providing grill base 712, fabricating a plurality of accessory parts that are tailored to a lifestyle (in this example a football lifestyle) such as those described above, and coupling the accessory parts to grill base 712. The methods for target marketing grill 710 generally include providing a grill base 712, selecting a theme for grill 710 that is tailored to a lifestyle (in this example a football lifestyle), fabricating and attaching accessory parts to the grill base that are tailored to the football lifestyle, and promoting the grill through marketing channels associated with people having a football lifestyle. The promoting step may include, for example, promoting the grill through football magazines, football television programs, through posters at football-related retail stores, through football product brochures, etc.

### Example 9

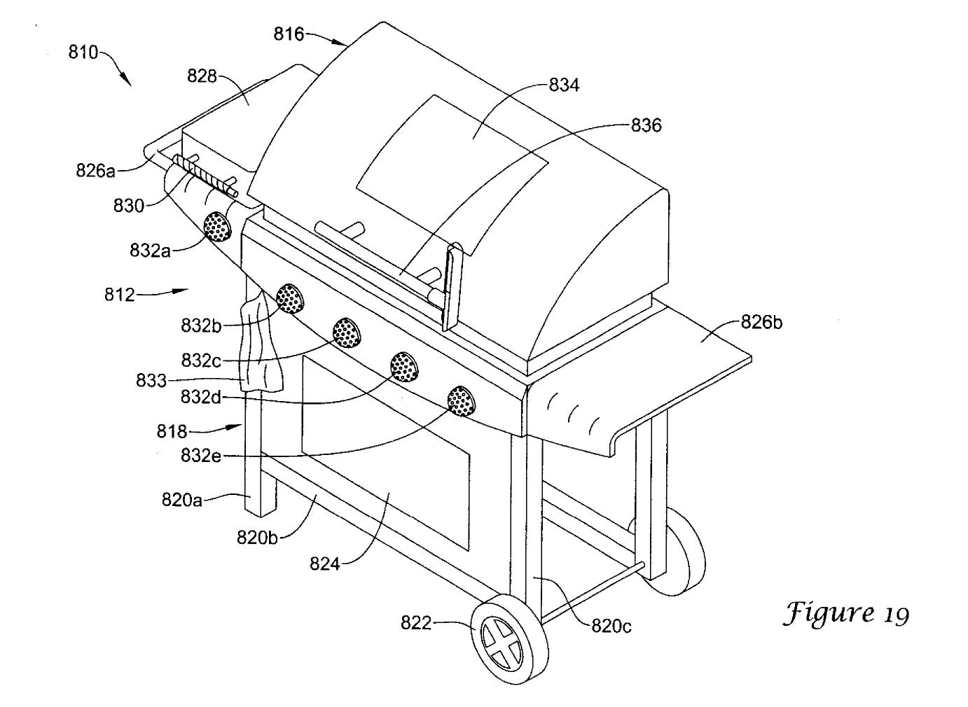

FIG. 19 is another example grill 810 having grill base 812. Grill base 812 may include a bowl (not shown, please refer to bowl 14 as depicted in FIG. 1A, which is the same in form and function) and lid or lid assembly 816 coupled to the bowl. Cart or cart assembly 818 may be coupled to base 812. Cart 818 may include a number of cart legs 820a/b/c and wheels 822. Front panel 824 may be coupled to cart 818 and/or legs 820a/b/c. One or more side tables 826a/b may also be coupled to base 812. On side table 826a, a side burner may be attached (not shown) that can be covered by side burner lid 828. Handle 830 may be attached to side burner lid 828. One or more control knobs 832a/b/c/d/e may be attached to base 812. Lid 816 may include front panel region 834 and handle 836. Handle 836 may be used to raise and lower lid 816.

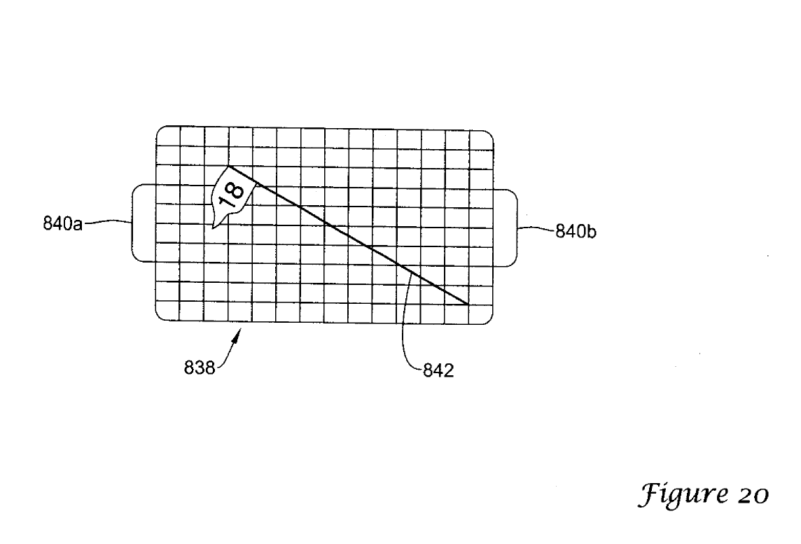

Turning now to FIG. 20 cooking grate 838 is depicted that can be seated within grill base 812, for example, within the bowl as is well know in the grilling art. Grate 838 may include one or more flanged or handle regions 840a/b that allow a user to easily remove and install grate 838. Grate 838 may also include panel region 842. In some embodiments, panel region 842 is located on the top surface of grate 838 so that region 842 can also function as a brand that can form branded sear marks on the food cooked thereon. Alternatively, panel region 842 may be positioned on the bottom surface of grate 838 so as to increase the structural integrity of grate 838 as well as provide a pleasing form that may be tailored to a lifestyle.

A number of the components of grill 810 are accessory parts that are tailored to a lifestyle. In this example, grill 810 is tailored to a golf lifestyle. With this in mind, handle 830, controls 832a/b/c/d/e, handle 836, and panel region 842 all resemble or take the form of articles associated with golf. For example, both handles 830/836 take the form of golf clubs or portions of golf clubs. Controls 832a/b/c/d/e all take the form of golf balls. Panel region 842 has the appearance of a golf related article such as a flag or pin, a golf course, a golf hole, a scorecard, etc. It can be readily appreciated that each of these accessory parts shares a common theme and each is tailored to the golf lifestyle.

In addition to the aforementioned accessory parts, front panel 824 as well as panel 834 on lid 816 may also be accessory parts that are tailored to a golf lifestyle. For example, in some embodiments, front panel 824 may include one or more golf-related illustrations (e.g., a flag or pin, a golf course, a golf hole, a scorecard, etc.) that gives panel 824 a form associated with golf. In addition, lid panel 834 may comprise one or more lid 816 etchings that take the form of the same or other articles associated with the golf lifestyle. It should be noted that panels 824/834 may have a shape that differs from what is shown in FIG. 19. For example, panels 824/834 may take up a different portion of grill base 812 (e.g., panel 834 may span the front surface of lid 816).

In some embodiments, panels 824/834 comprises panels that are directly added onto grill base 812. For example, panel 824 may be a panel that is affixed to cart 818. Alternatively, panel 824/834 may comprise alterations to existing structural aspects of grill 810. For example, panel 834 may comprise an etched region of lid 816.

The various accessory parts may have a number of alternative forms. For example, handles 830/836 could just as easily take the form of flags or pins, tees, etc. without departing from the spirit of the invention. In addition, knobs 832a/b/c/d/e could also resemble golf cars, golf clubs, etc. Moreover, other parts shown as being coupled to grill base 812 may, alternatively, be accessory parts that take the form of or resemble articles associated with a golf lifestyle. For example, legs 820a/b/c, wheels 822, tables 826a/b, or other parts may take the form of golf articles. In addition, other golf objects may be attached to grill base 812 such as a golf towel 833.

In some embodiments, the accessory parts utilized for grill 810 may be the actual articles that they represent. For example, handles 830/836 may be or include actual portions of golf clubs. Moreover, ball controls 832a/b/c/d/e may be made from golf balls. Alternatively, handles 830/836 and controls 832a/b/c/d/e may be molded from plastic, made from wood, made from metal, or made in any other suitable way so as to resemble the actual article.

Methods for manufacturing grill 810 generally include providing grill base 812, fabricating a plurality of accessory parts that are tailored to a lifestyle (in this example a golf lifestyle) such as those described above, and coupling the accessory parts to grill base 812. The methods for target marketing grill 810 generally include providing a grill base 812, selecting a theme for grill 810 that is tailored to a lifestyle (in this example a golf lifestyle), fabricating and attaching accessory parts to the grill base that are tailored to the golf lifestyle, and promoting the grill through marketing channels associated with people having a golf lifestyle. The promoting step may include, for example, promoting the grill through golf magazines, golf television programs, through posters at golf-related retail stores, through golf product brochures, etc.

It should be understood that this disclosure is, in many respects, only illustrative. Changes may be made in details, particularly in matters of shape, size, and arrangement of steps without exceeding the scope of the invention. The invention's scope is, of course, defined in the language in which the appended claims are expressed.

What is claimed is:

1. A method for target marketing grills to a lifestyle, comprising the steps of:
providing a grill base having a bowl and a lid; selecting a theme for the grill that is tailored to a lifestyle; fabricating a first accessory part for the grill that is tailored to the lifestyle; attaching the first accessory part to the grill base;
fabricating a second accessory part for the grill that is tailored to the lifestyle;
attaching the second accessory part to the grill base; and promoting the grill through marketing channels that are associated with persons having the lifestyle so as to attract sales of the grill to the persons who have the lifestyle.
